(19) United States
(12) Patent Application Publication
(10) Pub. No.: US 2025/0218117 A1
(43) Pub. Date: Jul. 3, 2025

(54) Method, Apparatus, Device, Vehicle, and Media for Creating a 3D Point Cloud Map

(71) Applicant: Robert Bosch GmbH, Stuttgart (DE)

(72) Inventors: Wuchao Wen, Suzhou (CN); Kai Liu, Suzhou (CN); Shengtao Jin, Suzhou (CN)

(21) Appl. No.: 19/001,767

(22) Filed: Dec. 26, 2024

(30) Foreign Application Priority Data
Dec. 29, 2023 (CN) 2023 1186 2774.0

(51) Int. Cl. G06T 17/00; G06T 7/70; G06V 10/44; G06V 10/56; G06V 10/82; G06V 20/56

(52) U.S. Cl. CPC G06T 17/00; G06T 7/70; G06V 10/44; G06V 10/56; G06V 10/82; G06V 20/56

(57) ABSTRACT

A method for creating a 3D point cloud map includes acquiring image frames from an image frame sequence of an external environment captured by a target camera of a vehicle. The method further includes processing the image frames using a feature point recognition model to identify a set of feature points in the image frames, along with a corresponding set of descriptors for the feature points. The feature point recognition model is a neural network model trained using a plurality of sample images of a same scene under different lighting intensities. The method further includes creating the 3D point cloud map of the external environment based on the set of descriptors. The method enables the obtained descriptors to include more image information, and further allows for an extraction of more matching feature points from the image when there are changes in lighting or view.

This application claims priority under 35 U.S.C. § 119 to patent application no. CN 2023 1186 2774.0, filed on Dec. 29, 2023 in China, the disclosure of which is incorporated herein by reference in its entirety.

The examples of the present disclosure generally relate to the field of autonomous driving, and specifically to methods, apparatuses, devices, vehicles, and media for creating 3D point cloud maps.

### BACKGROUND

With the development of automotive technology, there has been increasing research into autonomous driving. Autonomous driving technology refers to the ability of a vehicle to drive itself without human intervention, using various sensors and big data analysis to perceive the environment and make driving decisions. It involves the integrated application of a plurality of fields, including vehicle control, sensor technology, artificial intelligence, high-precision mapping, and more.

With the development of autonomous driving technology, in some intelligent valet parking applications, it is necessary to first collect environmental information to create a map of the environment. Then, this map is used to position the vehicle, enabling the completion of the entire autonomous parking function. For the map creation step, for example, when the user drives into an underground parking garage or an outdoor campus for the first time, a map should be created by using the vehicle's perception sensors to describe the features of the current scene, such as geometry, textures, and other characteristics. For the vehicle positioning step, according to the map constructed in the map creation step, the vehicle performs self-positioning by comparing the features of the current scene with those of the previously mapped scene. However, there are still many issues that need to be addressed during the autonomous parking process.

### SUMMARY

The examples of the present disclosure provide a method, an apparatus, a device, a vehicle, and a medium for creating a 3D point cloud map.

According to a first aspect of the present disclosure, a method for creating 3D point cloud map is provided. The method includes acquiring image frames from an image frame sequence of the external environment captured by a target camera of the vehicle. The method further includes processing the image frames using a feature point recognition model to identify a set of feature points in the image frames, along with a corresponding set of descriptors for the feature points. Where, the feature point recognition model is a neural network model trained using a plurality of sample images of the same scene under different lighting intensities. The method further includes creating a 3D point cloud map of the external environment based on a set of descriptors.

According to a second aspect of the present disclosure, an apparatus for creating 3D point cloud map is provided. The apparatus includes an image frame acquisition unit configured to acquire image frames from an image frame sequence captured by the target camera of the vehicle, directed at the external environment; an image frame processing unit configured to process the image frames using a feature point recognition model to determine a set of feature points in the image frame and a corresponding set of descriptors, wherein the feature point recognition model is a neural network model trained using a plurality of sample images of the same scene under different lighting intensities; and a 3D point cloud creation unit configured to create a 3D point cloud map of the external environment based on a set of descriptors.

According to a third aspect of the present disclosure, an computing device is provided. The computing device comprises at least one processor; and a memory coupled to the at least one processor and having instructions stored thereon that, when executed by the at least one processor, cause the computing device to perform the steps of the method of the first aspect of the present disclosure.

According to a fourth aspect of the present disclosure, a vehicle including the computing device according to the third aspect of the present disclosure is provided.

According to a fifth aspect of the present disclosure, a machine-readable storage medium is provided. The machine-readable storage medium stores machine-executable instructions, wherein the machine-executable instructions were executed by a processor, to implement the steps of the method in the first aspect of the present disclosure.

### BRIEF DESCRIPTION OF THE DRAWINGS

FIG. 1 illustrates a schematic diagram of an exemplary environment in which the device and/or method according to examples of the present disclosure may be implemented;

FIG. 2 illustrates a flowchart for creating a 3D point cloud map according to an example of the present disclosure;

FIG. 3 illustrates a schematic diagram of an example of feature points in an image frame acquired by a camera according to an example of the present disclosure;

FIG. 4 illustrates a schematic diagram of an example of feature point matching in an image frame according to an example of the present disclosure;

FIG. 5 illustrates a schematic diagram of an example of a vehicle at different time points according to an example of the present disclosure;

FIG. 6 illustrates a schematic diagram of an example process for triangulating feature points in an image frame according to an example of the present disclosure;

FIG. 7 illustrates a schematic diagram of an example triangulation process based on matching feature points based on an example of the present disclosure;

FIG. 8 illustrates a schematic diagram of an example process for optimizing the positions of map points according to an example of the present disclosure;

FIG. 9 illustrates a schematic diagram of an example for position a vehicle according to an example of the present disclosure;

FIG. 10 illustrates a schematic diagram of an apparatus for creating a 3D point cloud map according to an example of the present disclosure;

FIG. 11 illustrates a schematic block diagram of an exemplary device according to an example that is suitable to embody the content of the present disclosure.

In the various accompanying drawings, the same or corresponding numbers represent the same or corresponding portions.

### DETAILED DESCRIPTION

The examples of the present disclosure will be described in further detail below with reference to the accompanying drawings. While certain examples of the present disclosure are shown in the accompanying drawings, it should be understood that the present disclosure may be implemented in various forms and should not be construed as being limited to the examples set forth herein, rather these examples are provided for a more thorough and complete understanding of the present disclosure. It should be understood that the accompanying drawings and examples of the present disclosure are for exemplary purposes only and are not intended to limit the scope of protection of the present disclosure.

In the description of the examples of the present disclosure, the term “comprise” and other similar expressions should be understood as open-ended inclusion, that is, “comprising but not limited to”. The term “based on” should be understood as “at least partially based on”. The term “one example” or “this example” should be understood as “at least one example”. The terms “first”, “second”, etc. may refer to and represent different or the same object. The text below may comprise other specific and implicit meanings.

As mentioned earlier, there are still many issues that need to be addressed during the autonomous parking process. For example, in order to accurately park the vehicle in the desired location, an accurate map needs to be constructed. However, in traditional solutions, the constructed maps are not accurate, and the information contained in the maps is limited, which makes it difficult to achieve accurate vehicle positioning.

For example, in a traditional solution, a sequence of image frames captured by a camera of a panoramic surveillance system is used to create a map. However, in this solution, use manually constructed corner points and image information during image frame processing making the matching performance sensitive to changes in lighting and view. When lighting (or view) conditions change between the mapping and positioning steps, traditional manually created corner points and image information do not provide sufficient matching to perform re-positioning. Another traditional solution is to use overhead views generated by a plurality of cameras to create the map. However, for this approach, the close observation range of the overhead view may result in too few landmarks, making it difficult to construct a semantic map with sufficient accuracy. Additionally, a semantic map based solely on landmarks is difficult to use for vehicle re-positioning and cannot generate a semantic map in scenarios without (or with few) landmarks. Furthermore, the generated semantic map is a geometric map, and its structural differences are too small to find geometric matches between the global map and the local map.

In another traditional solution where maps are created using point clouds generated by radar, most vehicles are still not extensively equipped with LiDAR, and similar to semantic maps, LiDAR point cloud maps are also purely geometric maps, making them difficult to use for re-positioning (global positioning). It is evident that traditional map solutions are not accurate, and the constructed maps contain limited information, making it difficult to create an accurate map suitable for positioning.

To address at least the aforementioned and other potential issues, examples of the present disclosure provide a method for creating 3D point cloud map. In this method, the computing device acquires a sequence of image frames of the external environment captured by the target camera of the vehicle. It then uses a feature point recognition model to process the image frames in the sequence to generate a set of feature points and a corresponding set of descriptors. Where, the feature point recognition model is a neural network model trained using a plurality of sample images of the same scene under different lighting intensities. The computing device then uses the acquired set of descriptors to create a 3D point cloud map of the external environment. In this way, the obtained descriptors include more image information, and further allows for the extraction of more matching feature points from the image when there are changes in lighting or view, thereby enhancing the robustness of the system. Additionally, this approach also enables map creation in areas without landmarks.

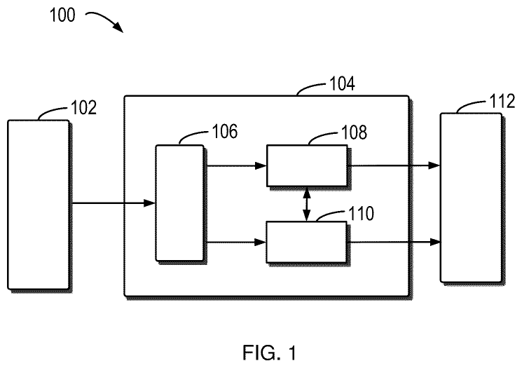

Examples of the present disclosure will be described in further detail below in conjunction with the accompanying drawings, wherein FIG. 1 illustrates an exemplary environment in which the device and/or method according to the examples of the present disclosure may be implemented;

As shown in FIG. 1, the example environment 100 includes a computing device 104, which is used to process the image frame sequence 102 collected by the vehicle's camera, directed at the external environment, to create a map of the external environment. For example, after the vehicle enters the garage, a 3D point cloud map of the garage that the vehicle passes through is constructed using the sequence of image frames captured by the camera during the vehicle's movement.

In one example, the computing device 104 can be an onboard computing device of the vehicle. In another example, the computing device 104 can be a domain computing device within the vehicle, such as a domain controller in the vehicle's auxiliary/autonomous driving domain. In yet another example, the computing device 104 may be implemented by any suitable computing device, including, but not limited to, personal computers, mobile devices, multiprocessor systems, consumer electronics, minicomputers, server, distributed computing environments comprising any one of the above-described systems or devices, etc.

The image frame sequence 102 is a video stream captured by a camera of the vehicle. In one example, the camera of the vehicle can be a fisheye camera. For example, when the vehicle intends to construct a 3D point cloud map of the garage, the image frame sequence 102 is a sequence of image frames captured by the fisheye camera as the vehicle drives within the garage. FIG. 1 illustrates that the computing device 104 receives the image frame sequence 102 captured by a single camera, which is merely an example and not a specific limitation of the present disclosure. The computing device 104 can receive image frame sequences captured by a plurality of cameras. For example, the computing device obtains four image frame sequences captured by four cameras mounted on the vehicle and then constructs a 3D point cloud map of the external environment according to these four image frame sequences.

When processing the image frames 102, the computing device 104 extracts image frames 106 from the image frame sequence 102 for processing. In one example, the computing device 104 processes each image frame in the image frame sequence 102. In another example, the computing device 104 processes one image frame from the image frame sequence at predetermined time intervals. The above examples are intended only to describe the present disclosure and are not a specific limitation of the present disclosure.

The computing device 104 further processes the image frame 106 using a feature point recognition model and then obtains a set of feature points 108 in the image frame 102 along with a corresponding set of descriptors 110 for these feature points 108. Feature points in an image frame refer to points in the image that have distinct characteristics or exhibit significant changes, such as edges, corners, or spots. The feature points in a set of feature points 108 identified includes the locations of the feature points in the image frame, such as the UV coordinates. The descriptor corresponding to a feature point is a vector, such as a 512-dimensional vector, which contains the feature information of the feature point. The feature point recognition model used in this identification process is a neural network model trained using a plurality of sample images of the same scene under different lighting intensities. For example, the feature point recognition model can be trained using images obtained from the same scene under different lighting conditions. Therefore, the descriptors obtained through this model have stronger light invariance and view invariance, enabling the acquisition of more matching feature points when lighting or view changes between the mapping and positioning steps, thereby enhancing the robustness of the system.

Each descriptor in a set of descriptors 110 corresponds to a feature point in a set of feature points 108. Since the entire image frame is processed when obtaining the descriptors, each descriptor is derived from the information of the entire image frame. Additionally, since the color information of the image is used during the image processing, each descriptor also indicates the color gradient changes of the corresponding feature point. In addition to processing the image frame 106 to extract feature points and descriptors, the computing device 104 also processes other image frames in the image frame sequence to obtain feature points and corresponding descriptors from those frames. The computing device 104 then uses a set of obtained feature points 108 and descriptors 110, along with the feature points and descriptors obtained from other image frames, to generate a 3D point cloud map 112 of the external environment.

In some examples, when the vehicle has a plurality of cameras, the image frames obtained from a plurality of image frame sequences by the cameras can be processed in the same way as image frame 106 to obtain the corresponding feature points and descriptors. Then, the computing device 104 uses the feature points and descriptors obtained from a plurality of image frames in the image frame sequence 102, along with the feature points and descriptors obtained from image frames in other image frame sequences, to generate a 3D point cloud map 112 of the external environment.

The method of the examples of the present disclosure allows for the construction of distant map points using feature points extracted from the original images. Moreover, the obtained descriptors have stronger illumination invariance and view invariance, which enables the acquisition of more matching feature points when illumination or view changes, thereby enhancing the robustness of the system.

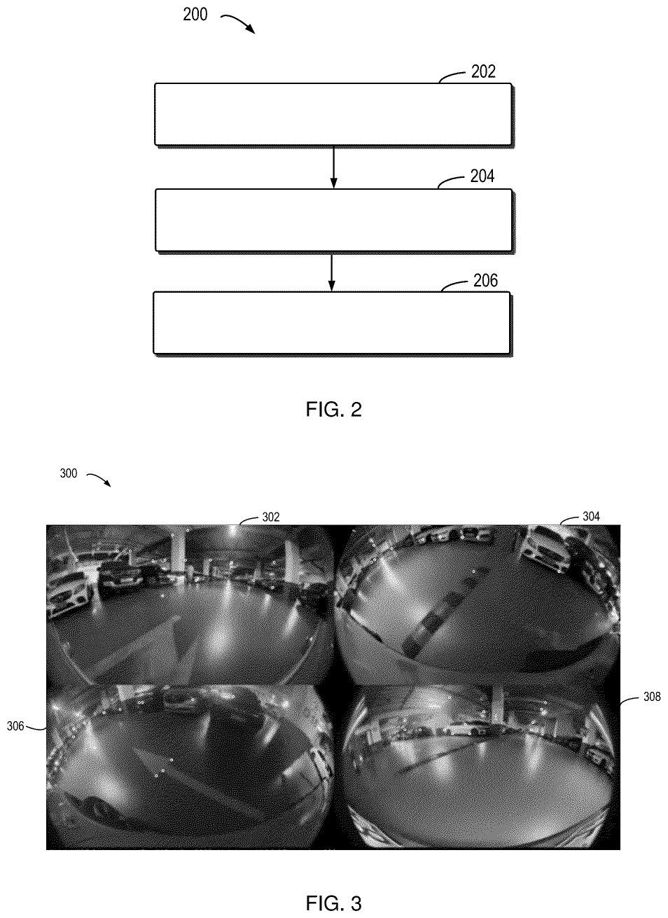

The above, in conjunction with FIG. 1, describes a block diagram of an exemplary system 100 in which the examples of the present disclosure may be implemented. The below, in conjunction with FIG. 2, describes a flowchart for creating a 3D point cloud map according to an example of the present disclosure. The method 200 can be executed on the computing device 104 in FIG. 1 or any suitable computing device or server.

In block 202, the computing device 104 acquires image frames from an image frame sequence of the external environment captured by a target camera of the vehicle. As shown in FIG. 1, the computing device 104 acquires an image frame 106 from the image frame sequence 102 and processes it. Additionally, the computing device 104 will also acquire other frames from the image frame sequence 102 for the same processing.

In block 204, the computing device 104 processes the image frame using a feature point recognition model to determine a set of feature points in the image frame and a corresponding set of descriptors for a set of feature points. The feature point recognition model is a neural network model trained using a plurality of sample images of the same scene under different lighting intensities. The above operations ensure that the obtained descriptors have stronger photometric invariance and view invariance, allowing more matching feature points to be obtained when there are changes in lighting or view. The feature points are represented by their positions in the image frame, while the descriptors are used to describe the feature information extracted from the image frame corresponding to the feature points. For convenience of description, the image frame can be referred to as the first image frame, a set of feature points can be referred to as the first set of feature points, and a set of descriptors can be referred to as the first set of descriptors.

When the computing device 104 processes the image frame 106 using the feature point recognition model, the data of the entire image frame is input into the feature point recognition model. Then, a set of feature points 108 and a corresponding set of descriptors 110 for the image frame 106 are obtained, where each feature point has a corresponding descriptor. The descriptor for a feature point is represented by a vector, which is determined according to the information from the entire image frame. Additionally, it can indicate the color gradient of the feature point.

In some examples, the computing device 104 selects either the image frame adjacent to the current image frame in the image frame sequence 102 or the next image frame extracted at a predetermined time interval as the second image frame. The feature point recognition model then processes the second image frame to obtain a second set of feature points in the second image frame and a second set of descriptors corresponding to the second set of feature points. Additionally, the computing device can process each image frame in the image frame sequence 102.

In some examples, when the vehicle is equipped with a plurality of cameras, the image frames in the image frame sequences from each camera can be processed. Thus, a plurality of sets of feature points and corresponding a plurality of sets of descriptors can be obtained, corresponding to a plurality of image frames in each of a plurality of image frame sequences.

In block 206, the computing device 104 creates a 3D point cloud map of the external environment based on a set of descriptors. For example, the computing device 104 can utilize the vector representations of the descriptors and further integrate information from other image frames to create the 3D point cloud map of the external environment.

In some examples, when creating the 3D point cloud map, the computing device calculates a set of matched feature points between the first image frame and the second image frame according to the first set of obtained descriptors for the first image frame and the second set of descriptors for the second image frame. In one example, the computing device calculates the distance between each descriptor in the first set of descriptors and each descriptor in the second set of descriptors. Since descriptors are represented by vectors, the distance between descriptors can be calculated by determining the distance between the vectors. When the distance between a descriptor in the first set of descriptors and a descriptor in the second set of descriptors is smaller than a threshold distance, it is determined that the feature points corresponding to the two descriptors are a match. Therefore, a set of matched feature points can be determined. In another example, the first set of descriptors and the second set of descriptors are input into a neural network model for feature point matching to determine a set of matched feature points. The neural network model is trained using matching sample feature points from a plurality of sample images. After obtaining a set of matched feature points, they can be used to create a 3D point cloud map.

In some examples, when the vehicle moves in the external environment, the vehicle's pose can be determined. In one example, the computing device 104 determines the pose according to data from the vehicle's odometer, such as using wheel odometer data to compute the pose. In another example, the computing device 104 determines the pose according to data obtained from an inertial measurement unit. In another example, the computing device 104 can determine the pose by combining data from the odometer and measurements obtained from the inertial measurement unit. The above examples are intended only to describe the present disclosure and are not a specific limitation of the present disclosure.

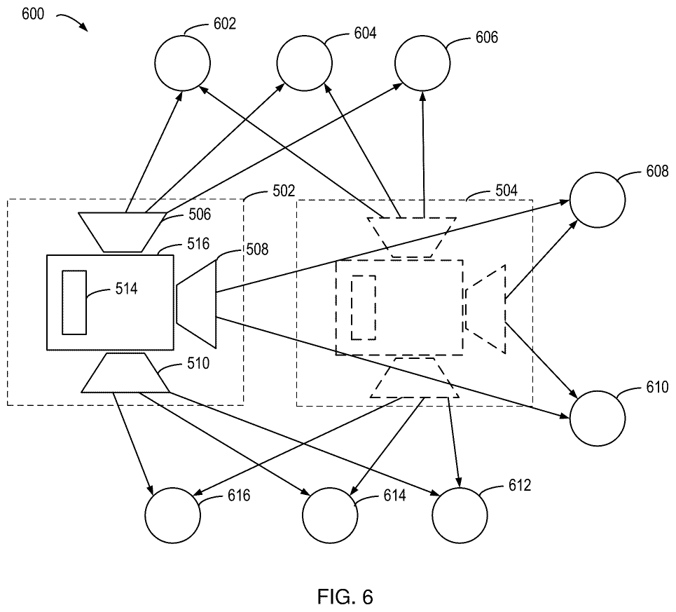

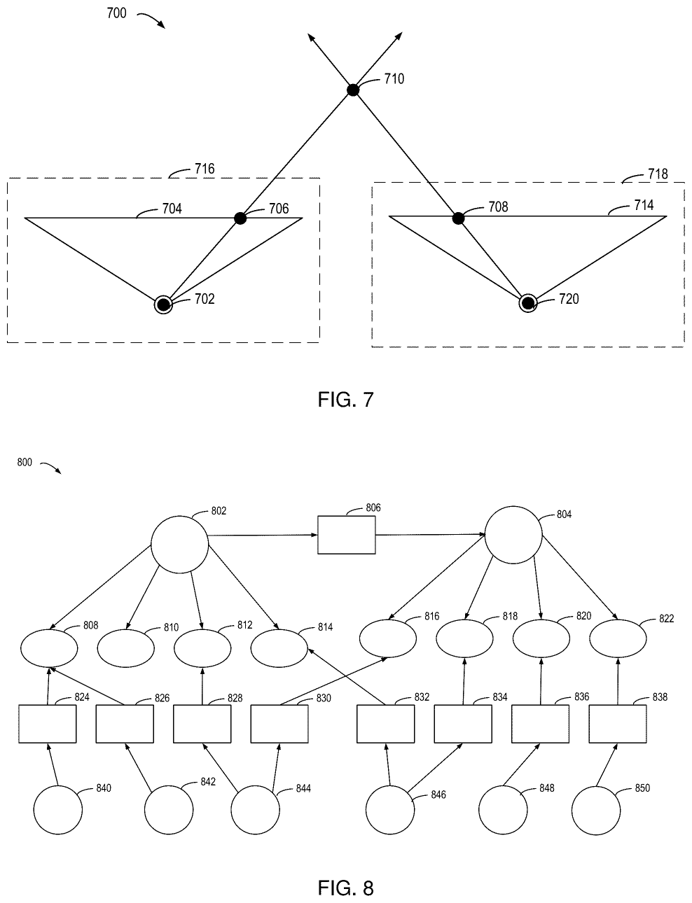

In some implementations, when creating the 3D point cloud map using a set of matching feature points, the computing device can use the first pose of the vehicle corresponding to the first image frame and the second pose of the vehicle corresponding to the second image frame. In addition, the computing device also needs to combine the position of each feature point in the image frame from a set of matching feature points to create the 3D point cloud map. In this process, the computing device determines the position of the map points corresponding to the matching feature points in 3D space based on the first and second poses. This process will be described in more detail below in conjunction with FIGS. 6 and 7. The computing device 104 also needs to optimize the positions of the map points to generate an accurate 3D point cloud map. The optimization process is described below in conjunction with FIG. 8.

In some examples, after constructing a 3D point cloud map of the external environment, when the vehicle revisits the same environment, it can be positioned according to the constructed 3D point cloud map. Therefore, after generating the 3D point cloud map, when the vehicle revisits the external environment, the computing device needs to capture target image frames obtained by the camera. The computing device then further determines a set of target feature points in the target image frame and a set of target descriptors corresponding to a set of target feature points. The computing device matches a set of obtained target descriptors with the descriptors from the third image frame in the image frame sequence used to build the map to determine a set of matching target feature points. In one example, the computing device first determines the vehicle's pose when obtaining the target image frame, then searches for the image frame from the image frame sequence used to generate the map that corresponds to the pose or the image frame with the closest distance with the pose as the third image frame. In another example, the target image frame can be matched with the image frames in the image frame sequence to acquire the most similar image frame as the third image frame. The above examples are intended only to describe the present disclosure and are not a specific limitation of the present disclosure. Then, the computing device can obtain a set of map points corresponding to a set of matched target feature points, and according to the positions of these map points, the device can calculate the vehicle's position in the 3D point cloud map.

In some examples, the vehicle is equipped with a plurality of cameras, and a plurality of cameras include target camera. Therefore, a plurality of cameras can capture a plurality of image frame sequences for the external environment. The computing device 104 can use a plurality of sets of descriptors corresponding to a plurality of image frames in each image frame of a plurality of image frame sequences to create a 3D point cloud map of the external environment. When constructing a map using a plurality of image frame sequences obtained from a plurality of cameras, the 3D point cloud map can be more accurate due to the increased information about the external environment captured by the images.

The method of the examples of the present disclosure allows for the construction of distant map points using feature points extracted from the original images. Moreover, the obtained descriptors have stronger illumination invariance and view invariance, which enables the acquisition of more matching feature points when illumination or view changes, thereby enhancing the robustness of the system. Additionally, it allows for map creation even in areas without landmarks.

The above, in conjunction with FIG. 2, describes a flowchart for creating a 3D point cloud map according to an example of the present disclosure. The below, in conjunction with FIGS. 3 to 8, describes an example process for constructing a 3D point cloud map of the external environment. Wherein, FIG. 3 illustrates a schematic diagram of an example of feature points in an image frame acquired by a camera according to an example of the present disclosure.

In the example 300 shown in FIG. 3, the vehicle is equipped with four cameras, which are arranged around the vehicle. As a result, the computing device can obtain four image frames 302, 304, 306, and 308 of the surroundings of the vehicle at the same time. By using the feature point recognition model to process these four image frames, the feature points and their corresponding descriptors for each image frame can be obtained. For example, the white points in the four image frames 302, 304, 306, and 308 indicate the obtained feature points, which can be represented by their UV coordinates in the image frames. FIG. 3 shows a vehicle with four cameras, which is just an example and not a specific limitation of the present disclosure. In some examples, the vehicle can be equipped with any suitable number of cameras to capture image frame sequences.

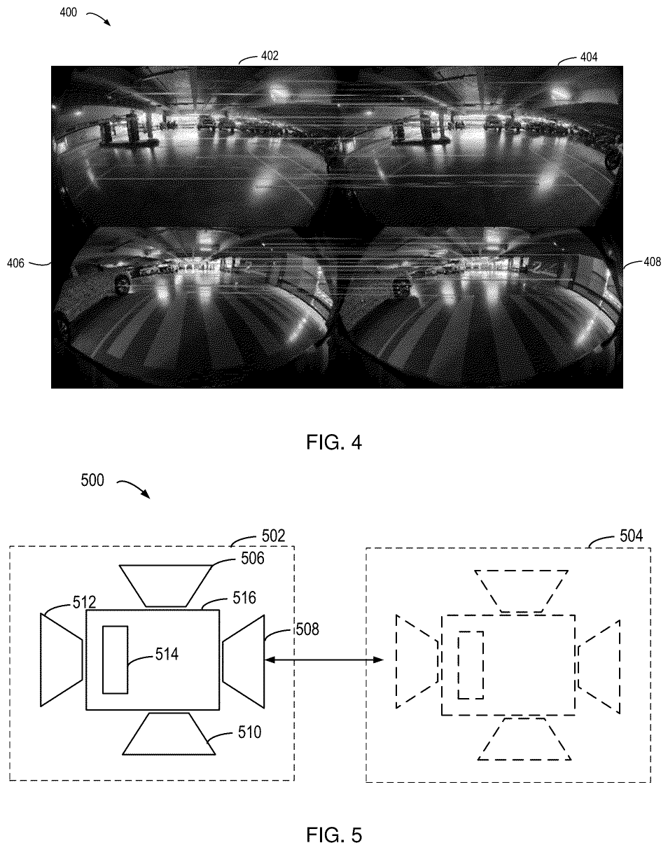

Next, a schematic diagram of an example of feature point matching of an image according to the example of the present disclosure is described in FIG. 4. In example 400, image frames 402 and 406 are obtained by the front and rear cameras of the vehicle at time T1, while image frames 404 and 408 are obtained by the front and rear cameras of the vehicle at time T2. After processing these four image frames with a feature point recognition model, the feature points and corresponding descriptors for each image frame can be obtained. Then, the computing device 104 uses the descriptors to match the feature points from the image frames obtained by the same camera at different times. In the matching process, feature point matching is determined according to the descriptors of the feature points. As shown in FIG. 4, the matched feature points between the two image frames 402 and 404 captured by the front camera of the vehicle, and the matched feature points between the two image frames 406 and 408 captured by the rear camera, are represented by lines connecting the corresponding points.

After obtaining the matched feature points, the next step is to determine the pose of the vehicle. As shown in FIG. 5, it illustrates a schematic diagram of an example of a vehicle at different time points according to an example of the present disclosure; In example 500, block 502 represents the area where the vehicle 516 is located at time T1, and block 504 represents the area where the vehicle 516 is located at time T2. The vehicle 516 is equipped with four cameras 506, 508, 510, and 512 to capture information about the surrounding environment. The vehicle 516 also includes an inertial measurement unit 514, which is used to determine the vehicle's pose, including its position and orientation. For example, the position is represented by (x, y, z) coordinates, which poses are represented by pitch angle (Pitch), yaw angle (Yaw), and rolling angle (Roll). Therefore, the computing device can determine the vehicle's pose at time T1 and also calculate the vehicle's second pose at time T2. Additionally, the computing device can also calculate the relative pose of the vehicle between time T1 and time T2.

After determining the vehicle's pose at different times corresponding to different image frames, triangulation methods can be used to determine the positions of the map points corresponding to the matched feature points in the image frames. The below, in conjunction with FIGS. 6 and 7, further describes the process. FIG. 6 illustrates a schematic diagram of an example process for triangulating feature points in an image frame according to an example of the present disclosure.

In the example 600 shown in FIG. 6, only three cameras 506, 508, and 510 of the vehicle 516 from FIG. 5 are shown to determine the positions of the map points corresponding to the matched feature points. Block 502 represents the area where the vehicle 516 is located at time T1, and block 504 represents the area where the vehicle 516 is located at time T2.

In example 600, the inertial measurement unit 514 can determine the first pose of the vehicle at block 502. Since the relative positions of the cameras on the vehicle are fixed, the pose of each camera can be determined. Similarly, the second pose of the vehicle at block 504 and the pose of each camera can also be determined. For matching feature points in image frames obtained by the same camera at different times, they have extension lines from the camera's optical center to the feature points. The extension lines from the optical center of the camera to the matching feature points at the two different time moments have an intersection, which can be used as a map point in the map. The map point is the actual position of the matching feature point in the external environment. Therefore, the positions of map points 602, 604, 606, 608, 610, 612, 614, and 616 can be determined.

To describe the process in more detail, the below, in conjunction with FIG. 7, illustrates a schematic diagram of an example of triangulation process of matching feature points based on a single camera according to an example of the present disclosure.

In example 700, blocks 716 and 718 show the areas where the same camera is located at time T1 and T2, respectively. In examples 702 and 720 respectively show the optical centers of the camera at different times. The obtained image frames 704 and 718 contain matching feature points 706 and 708. The computing device extends the lines from the optical center to the matching feature points, and these two lines intersect at a map point 710. The map point is the actual point in space corresponding to feature points 706 and 708. Since the optical centers' poses at the two moments are known, and the positions of the feature points in the image frames are also determined, the actual position of the map point can be calculated. The map points of other matched feature points in FIG. 6 are also determined in this way.

After determining the position of the map points, the position needs to be optimized. The below, in conjunction with FIG. 8, illustrates a schematic diagram of an example process for optimizing the positions of map points according to an example of the present disclosure.

In the example 800 of FIG. 8, bundle adjustment can be used to optimize the position of feature points. For example, according to the vehicle's pose at time T1 (802), the poses of the four cameras on the vehicle can be determined as 808, 810, 812, and 814. Based on the vehicle's pose at time T2 (804), the poses of the four cameras can be determined as 816, 818, 820, and 822. Further, the location of the map points 840, 842, 844, 846, 848, 850 corresponding to the matching feature points has been preliminarily determined. At this point, bundle adjustment can be used to optimize the positions of the matched feature points corresponding to map points 840, 842, 844, 846, 848, and 850, the positions of the matched feature points in the image frame, and the positions of the vehicle or the camera, to minimize the sum of the visual residuals 824, 826, 828, 830, 832, 834, 836, and 838, which correspond to the matched features, and the trajectory estimation residuals 806 related to the vehicle's position. For example, by inputting the above data into a nonlinear least squares method, the positions of the map points and the vehicle can be determined when the sum of the residuals is minimized. These positions can then be taken as the final optimized locations. The final positions of these map points can be used to determine a 3D point cloud map.

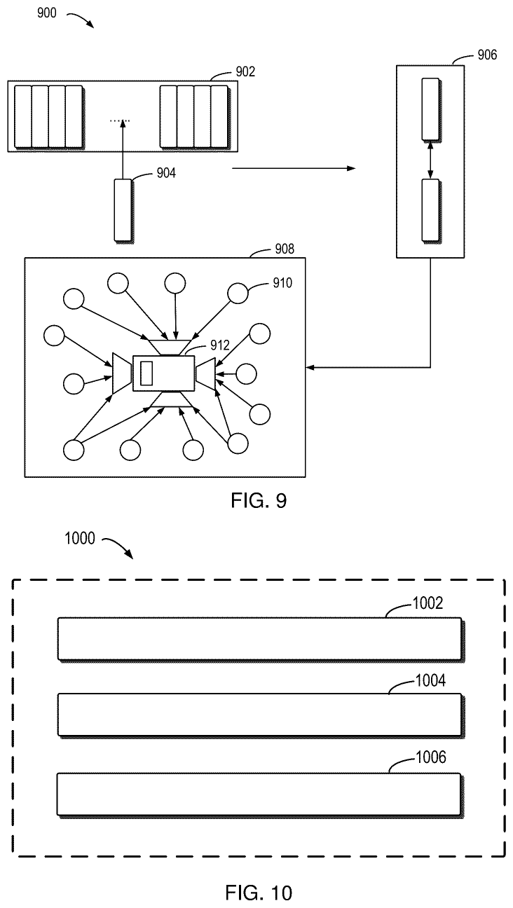

The above, in conjunction with FIGS. 3 to 8, describes a process for constructing a 3D point cloud map of the external environment. The below, in conjunction with FIG. 9, illustrates a schematic diagram of an example for positioning a vehicle according to an example of the present disclosure.

In example 900, an image frame sequence 902 is shown, which is used for constructing a 3D point cloud map, and each image frame contains a set of feature points and a corresponding set of descriptors. For the vehicle 912 re-entering the external environment after the 3D point cloud map has been constructed, the obtained image frame 904 needs to be matched to the corresponding image frame from the image frame sequence. For example, the corresponding image frame can be identified based on the vehicle's pose associated with image frame 904 or by using an image matching algorithm to find the corresponding image frame. Then, at block 906, the descriptors of the two image frames are matched. The descriptor matching process can be determined by calculating the distance between descriptors or by using a neural network model designed for feature point matching. Then, at block 908, the vehicle's position in the 3D point cloud map is determined based on the locations of the map points corresponding to the matched feature points. For example, the computing device calculates the vehicle's position using the location of map point 910 and other map points.

FIG. 10 further illustrates a schematic diagram of an apparatus for creating a 3D point cloud map according to an example of the present disclosure. The apparatus 1000 can be applied to a computing device 104, which may include a plurality of modules for performing the corresponding steps in the method 200 discussed in FIG. 2. As shown in FIG. 10, the apparatus 1000 includes an image frame acquisition unit 1002, configured to acquire image frames from an image frame sequence captured by the target camera of the vehicle, directed at the external environment; a descriptor determination unit 1004, configured to process the image frames using a feature point recognition model to determine a set of feature points in the image frame and a corresponding set of descriptors, wherein the feature point recognition model is a neural network model trained using a plurality of sample images of the same scene under different lighting intensities; and a 3D point cloud creation unit 1006, configured to create a 3D point cloud map of the external environment based on a set of descriptors.

In some examples, each descriptor in a set of descriptors is determined based on the entire image frame and indicates the color gradient of the corresponding feature points in a set of feature points.

In some examples, wherein the image frame is the first image frame, a set of feature points is the first set of feature points, and a set of descriptors is the first set of descriptors, the apparatus 1000 further includes: The second image processing unit, configured to process a second image frame in the image frame sequence using the feature point recognition model to determine a set of feature points in the second image frame and a second set of descriptors corresponding to the second set of feature points.

In some examples, the 3D point cloud map creation unit 1006 includes: A feature point matching unit, configured to determine a set of matched feature points between the first image frame and the second image frame based on the first set of descriptors and the second set of descriptors; and a first map creation unit, configured to create a 3D point cloud map based on a set of matched feature points.

In some examples, the first map creation unit comprises: A pose determination unit, configured to determine the first pose of the vehicle corresponding to the first image frame and the second pose of the vehicle corresponding to the second image frame; and a second map creation unit, configured to create a 3D point cloud map based on the first pose, the second pose, and a set of matched feature points.

In some examples, wherein the pose determination unit comprises: A second pose determination unit, configured to determine the first pose and the second pose based on at least one of the following: Data from the vehicle's odometer or data from the vehicle's inertial measurement unit.

In some examples, the second map creation unit is configured to comprise: A position determination unit, configured to determine the position of the map points corresponding to the matched feature points in a set of matched feature points based on the first pose and the second pose; and an optimization unit, configured to generate a 3D point cloud map by optimizing the position.

In some examples, the feature point matching unit includes: A first matching unit, configured to determine a set of matched feature points based on the distance between descriptors in the first set of descriptors and descriptors in the second set of descriptors; or the first matching unit, configured to determine a set of matched feature points by applying a neural network model for feature point matching to the first set of descriptors and the second set of descriptors.

In some examples, the apparatus 1000 further comprises: The target image frame acquisition unit, configured to acquire a target image frame captured by the target camera after generating the 3D point cloud map; the target descriptor determination unit, configured to determine a set of target feature points in the target image frame and a corresponding set of target descriptors; the target feature point determination unit, configured to determine a set of matched target feature points between the target image frame and the third image frame in the image frame sequence based on a set of target descriptors; and the position determination unit, configured to determine the vehicle's position in the 3D point cloud map based on the positions of a set of map points corresponding to the matched target feature points.

In some examples, wherein the vehicle has a plurality of cameras, including a target camera, and the a plurality of cameras capture a plurality of image frame sequences for the external environment; where, the 3D point cloud map creation unit includes: Point cloud map creation unit, configured to create a 3D point cloud map of the external environment based on a plurality of sets of descriptors corresponding to a plurality of image frames in each image frame of a plurality of image frame sequences.

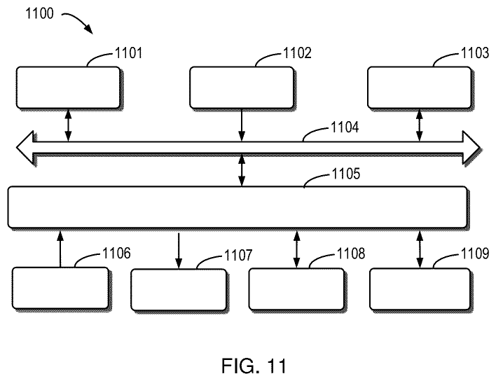

FIG. 11 illustrates a schematic block diagram of an exemplary device 1100 that may be used to implement the examples of the present disclosure. The computing device 104 of FIG. 1 may be implemented using the device 1100. As shown in the figure, the device 1100 comprises a central processing unit (CPU) 1101, which can execute various appropriate actions and processing based on computer program instructions stored in a read-only memory (ROM) 1102 or computer program instructions loaded onto a random access memory (RAM) 1103 from a storage unit 1108. Various programs and data required for the operation of the device 1100 may also be stored in the RAM 1103. The CPU 1101, the ROM 1102, and the RAM 1103 are interconnected through a bus 1104. An input/output (I/O) interface 1105 is also connected to the bus 1104.

Multiple components in the device 1100 are connected to the I/O interface 1105, such as: an input unit 1106, such as a keyboard, mouse, etc.; an output unit 1107, such as various types of display, speaker, etc.; a storage unit 1108, such as a disk, optical disc, etc.; as well as a communication unit 1109, such as a network interface card, modem, wireless communication transceiver, etc. The communication unit 1109 allows the device 1100 to exchange information/data with other devices through computer networks such as the Internet and/or various telecommunication networks.

The various processes and processing described above, such as the method 200, may be executed by the processing unit 1101. For example, in some examples, method 200 can be implemented as a computer software program tangibly contained in a machine-readable medium, such as the storage unit 1108. In some examples, part or all of the computer programs may be loaded and/or installed onto the device 1100 through the ROM 1102 and/or the communication unit 1109. When the computer program is loaded onto the RAM 1103 and executed by the CPU 1101, one or more actions of the method 200 described above may be performed.

The present disclosure may be a method, apparatus, system and/or computer program product. The computer program product may comprise a computer-readable storage medium uploaded with computer-readable program instructions for performing various aspects of the present disclosure.

The computer-readable storage medium may be a tangible device that maintains and stores instructions used to instruct execution devices. The computer-readable storage medium, for example, may be—but is not limited to—an electrical storage device, magnetic storage device, optical storage device, electromagnetic storage device, semiconductor memory device, or any suitable combination of the above. More specific examples of the computer-readable storage medium (a non-exhaustive list) comprise: random access memory (RAM), read-only memory (ROM), wipeable programmable read-only memory (EPROM or flash memory), static random access memory (SRAM), and any suitable combination of the above. The computer-readable storage medium used herein is not to be construed as transient signals per se, such as radio waves or other freely propagating electromagnetic waves, electromagnetic waves propagating through waveguides or other transmission media (e.g., light pulses through fiber optic cables), or electrical signals transmitted through wires.

The computer-readable program instructions described herein may be downloaded to various computing/processing devices from computer-readable storage medium, or downloaded from networks, such as the Internet, a local area network, a wide-area network and/or a wireless network to external computers or external storage devices. The networks may comprise copper transmission cables, optical fiber transmissions, wireless transmissions, routers, firewalls, switches, gateway computers, and/or edge servers. The network adapter card or network interface in each computing/processing device receives the computer-readable program instructions from the network and forwards the computer-readable program instructions for storage in computer-readable storage medium of each computing/processing device.

The computer program instructions used to execute the operations of the present disclosure may be assembly instructions, instructions set architecture (ISA) instructions, machine instructions, machine-related instructions, microcode, firmware instructions, state-setting data, or source code or object code written with any combination of one or many programming languages, with the programming languages including object-oriented programming languages such as Smalltalk, C++, etc., as well as conventional procedural programming languages such as “C” language or similar programming languages. Computer-readable program instructions may be fully executed on the user's computer, partially executed on the user's computer, executed as an independent software package, partially executed on the user's computer and partially executed on a remote computer, or fully executed on a remote computer or server. Where a remote computer is involved, the remote computer may be connected to the user's computer through any type of network, including local area network (LAN) or wide area network (WAN), or it may be connected to an external computer (such as by using an Internet service provider for Internet connection). In some examples, the state information of computer-readable program instructions is used to personalize custom electronic circuits, such as a programmable logic circuit, field-programmable gate array (FPGA) or programmable logic array (PLA), wherein the electronic circuit is able to execute computer-readable program instructions, thereby achieving the various aspects of the present disclosure.

Various aspects of the present disclosure are described herein with reference to flow charts and/or block diagrams depicting methods, apparatus (systems), and computer program products according to the examples of the present disclosure. It should be understood that every block in the flow charts and/or block diagrams and the combinations of various blocks in the flow charts and/or block diagrams may be implemented by computer-readable program instructions.

These computer-readable program instructions may be provided to general-purpose computers, dedicated computers or the processing units of other programmable data processing devices, thereby producing a type of machine, such that when these instructions are executed by the computers or processing units of other programmable data processing devices, an apparatus that realizes the functions/actions stipulated in one or more boxes in the flow charts and/or block diagrams is produced. These computer-readable program instructions may also be stored in computer-readable storage medium, enabling computers, programmable data processing devices, and/or other devices to operate in a specific manner. Therefore, the computer-readable media containing instructions comprise a manufactured product that includes instructions for implementing various aspects of the functions/actions specified in one or more boxes in the flow charts and/or block diagrams.

The computer-readable program instructions may also be loaded onto a computer, other programmable data processing devices, or other devices, enabling a series of operational steps to be executed on the computer, other programmable data processing devices, or other devices to generate a computer-implemented process. This enables the instructions executed on the computer, other programmable data processing devices, or other devices to implement the functions/actions specified in one or more boxes in the flow charts and/or block diagrams.

The flow charts and block diagrams in the accompanying drawings show the system architecture, functions and operations that may be implemented based on the systems, methods and computer program products according to the plurality of examples of the present disclosure. Regarding this, every block in the flow chart or block diagram can represent a part of a module, program section or instructions, wherein the part of the module, program section or instructions contains one or a plurality of executable instructions that are used to implement the stipulated logic function. In some alternative implementations, the occurrence of the function indicated in the blocks may also differ from the sequence indicated in the accompanying drawings. For example, two continuous blocks may actually be substantially performed in a concurrent manner and they may also sometimes be performed in reverse order, depending on the functions involved. It must also be noted that every block in the block diagrams and/or flow charts, as well as combinations of blocks in the block diagrams and/or flow charts may be implemented by dedicated hardware-based systems used to perform the stipulated functions or actions, or implemented by using combinations of dedicated hardware and computer instructions.

The various examples of the present disclosure have been described above. The descriptions provided are exemplary and not exhaustive, and they are also not limited to the disclosed examples. Many modifications and variations will be apparent to those skilled in the art without departing from the scope and spirit of the described examples. The selection of terms used in this text aims to best explain the principles and actual application of the various examples, the technological improvements in the technology in the market, or allow others of ordinary skill in the art to understand the various examples disclosed in this text.

What is claimed is:

1. A method for creating a 3D point cloud map, comprising:
acquiring image frames from an image frame sequence of an external environment captured by a target camera of a vehicle;
processing an image frame in the image frame sequence using a feature point recognition model to identify a set of feature points in the image frame, along with a corresponding set of descriptors for the set of feature points, wherein the feature point recognition model is a neural network model trained using a plurality of sample images of a same scene under different lighting intensities; and
creating the 3D point cloud map of the external environment based on the set of descriptors.

2. The method according to claim 1, wherein each descriptor in the set of descriptors is determined based on an entire image frame and indicates a color gradient of a corresponding feature point in the set of feature points.

3. The method according to claim 1, wherein the image frame is a first image frame, the set of feature points is a set of first feature points, and the set of descriptors is a set of first descriptors, the method further comprising:
processing a second image frame in the image frame sequence using the feature point recognition model to determine a set of second feature points in the second image frame and a set of second descriptors corresponding to the set of second feature points.

4. The method according to claim 3, wherein creating the 3D point cloud map for the external environment based on the set of descriptors comprises:
determining a set of matching feature points between the first image frame and the second image frame based on the set of first descriptors and the set of second descriptors; and
creating the 3D point cloud map based on the set of matching feature points.

5. The method according to claim 4, wherein creating the 3D point cloud map based on the set of matching feature points comprises:
determining a first pose of the vehicle corresponding to the first image frame and a second pose of the vehicle corresponding to the second image frame; and
creating the 3D point cloud map based on the first pose, the second pose, and the set of matching feature points.

6. The method according to claim 5, wherein determining the first pose of the vehicle corresponding to the first image frame and the second pose of the vehicle corresponding to the second image frame comprises:
determining the first pose and the second pose based on at least one of (i) data from an odometer of the vehicle, or (ii) data from an inertial measurement unit of the vehicle.

7. The method according to claim 5, wherein creating the 3D point cloud map based on the first pose, the second pose, and the set of matching feature points comprises:
based on the first pose and the second pose, determining a position of map points corresponding to the matching feature points in the set of matching feature points; and
generating the 3D point cloud map by optimizing the positions of the map points.

8. The method according to claim 4, wherein determining the set of matching feature points between the first image frame and the second image frame based on the set of first descriptors and the set of second descriptors comprises:
determining the set of matching feature points based on a distance between the descriptors in the set of first descriptors and the descriptors in the set of second descriptors; or
determining the set of matching feature points by applying a neural network model used for feature point matching to the set of first descriptors and the set of second descriptors.

9. The method according to claim 3, further comprising:
acquiring a target image frame captured by the target camera after generating the 3D point cloud map;
determining a set of target feature points in the target image frame and a corresponding set of target descriptors for the set of target feature points;
based on the set of target descriptors, determining a set of matching target feature points between the target image frame and a third image frame in the image frame sequence; and
determining a position of the vehicle in the 3D point cloud map based on the position of a set of map points corresponding to the set of matching target feature points.

10. The method according to claim 1, wherein:
the vehicle has a plurality of cameras,
the plurality of cameras include the target camera, and
the plurality of cameras capture a plurality of image frame sequences directed at the external environment; and
creating the 3D point cloud map of the external environment based on the set of descriptors comprises:
creating the 3D point cloud map of the external environment based on the plurality of sets of descriptors corresponding to a plurality of image frames in each image frame of a plurality of image frame sequences.

11. An apparatus for creating a 3D point cloud map, comprising:
an image frame acquisition unit, configured to acquire image frames from an image frame sequence captured by a target camera of a vehicle, directed at an external environment;
an image frame processing unit, configured to processing the image frames using a feature point recognition model to identify a set of feature points in the image frames, along with a corresponding set of descriptors for the set of feature points, wherein the feature point recognition model is a neural network model trained using a plurality of sample images of a same scene under different lighting intensities; and
a 3D point cloud map creation unit, configured to create the 3D point cloud map of the external environment based on the set of descriptors.

12. A computing device, comprising:
at least one processor; and
a non-transitory memory, coupled to the at least one processor, and having instructions stored thereon that, when the instructions are executed by the at least one processor, cause the computing device to perform the method according to claim 1.

13. A vehicle, comprising:
a camera; and
a computing device according to claim 12.

14. A non-transitory machine-readable storage medium storing machine-executable instructions, wherein the machine-executable instructions are executed by a processor to implement the method according to claim 1.
